(19) United States
(12) Patent Application Publication
(10) Pub. No.: US 2014/0086033 A1
(43) Pub. Date: Mar. 27, 2014

(54) METHOD AND APPARATUS FOR INSPECTING THERMAL ASSIST TYPE MAGNETIC HEAD DEVICE

(71) Applicant: Hitachi High-Technologies Corporation, Tokyo (JP)

(72) Inventors: Teruaki TOKUTOMI, Kami (JP); Kaifeng ZHANG, Yokohama-shi (JP)

(73) Assignee: Hitachi High-Technologies Corporation, Tokyo (JP)

(21) Appl. No.: 13/967,619

(22) Filed: Aug. 15, 2013

(30) Foreign Application Priority Data
Sep. 24, 2012 (JP) 2012-209250
Sep. 24, 2012 (JP) 2012-209251

(51) Int. Cl. G11B 20/18

(52) U.S. Cl. CPC G11B 20/1816
USPC 369/53.38

(57) ABSTRACT

In order to enable inspection of the physical shape of a near-field light emitting portion of a thermal assist type magnetic head, a thermal assist type magnetic head device is placed on a table movable in a plane, a probe fixed to a cantilever scans a plane apart at a constant distance from the surface of the sample placed on the table while moving the table in a plane, the displacement of the cantilever is detected by applying light to the scanning cantilever and detecting reflected light from the cantilever, an atomic force microscope (AFM) image of the thermal assist type magnetic head device is formed using information about the detected displacement of the cantilever and positional information about the table, and the quality of a physical shape including the size or typical dimensions of the near-field light emitting portion is determined by processing the formed AFM image.

### BACKGROUND

The present invention relates to a method for inspecting a thermal assist type magnetic head and an apparatus therefor that inspect a thin film thermal assist type magnetic head, and more particularly to a method for inspecting a thermal assist type magnetic head device and an apparatus therefor that can inspect the physical shape of a near-field light generating region generated by a thermal assist type magnetic head, and it is difficult to inspect the physical shape using a technique such as an optical microscope.

It is planned to adopt a thermal assist type magnetic head as a next generation hard disk head by hard disk manufacturers. The width of a near-field light generated from a thermal assist type magnetic head is 20 nm or less, and the width determines the write track width on a hard disk. An inspection method for the intensity distribution of a near-field light in actual operation or the physical shape of a light emitting portion is an important problem that is not solved yet. Although it is presently possible to measure the shape of a head (a device) using a scanning electron microscope (SEM), the measurement is destructive inspection, which is difficult to be applied to total inspection for mass production.

On the other hand, track width inspection for a hard disk magnetic head so far is performed in the final process of magnetic head manufacture in a HGA (Head Gimbal Assembly) state or in a pseudo HGA state. In order to meet demands such as the improvement of production costs and the early feedback of manufacture process conditions, Japanese Patent Application Laid-Open Publication No. 2009-230845 discloses an inspection method performed in a state of a row bar cut out of a wafer.

Moreover, Japanese Patent Application Laid-Open Publication No. 6-323834 describes that a sample is laterally oscillated on an atomic force microscope, the phase and amplitude of the flexure or the torsional oscillation of a cantilever excited by the lateral oscillation are simultaneously measured, and an oscillation amplitude image and an oscillation phase difference image are formed.

Furthermore, Japanese Patent Application Laid-Open Publication No. 2002-277378 discloses a configuration in which a cantilever is always oscillated at a resonance frequency because the resonance frequency of the cantilever is changed in response to the physical properties of a sample contacting a probe and the output of a phase comparator is changed in response to a change in the phase of an output signal in the case of measuring the Q value of the cantilever of an atomic force microscope.

In addition, Japanese Patent Application Laid-Open Publication No. 2002-269708 describes that a magnetic force microscope is used to measure a phase change in the oscillations of a probe according to a magnetic field generated from a magnetic head to which an amplitude modulation signal is applied and a change in phase displacement with resect to a change in the value of the amplitude modulation signal is measured as the magnetic field frequency dependency of the head.

### SUMMARY

There is no dedicated inspection apparatus for the purpose of inspecting the physical shape of a near-field light generated by a head or a near-field light emitting portion yet. Moreover, presently, such an inspection apparatus is used in a state of a row bar cut out of a wafer in performance inspection for a magnetic head. However, it is also necessary that an inspection apparatus for use in an early stage of head manufacture, in a row bar, be developed for the thermal assist type magnetic head.

Japanese Patent Application Laid-Open Publication No. 2009-230845 describes that the state of a magnetic field generated by a magnetic head is directly observed using a magnetic force microscope or the like. However, it is not described that the physical shape of a near-field light generating region (the size or typical dimensions of a near-field light generating region) of the thermal assist type magnetic head is inspected.

Japanese Patent Application Laid-Open Publication No. 6-323834 describes that an oscillation amplitude image and an oscillation phase image are formed as images which strongly reflect friction force. However, it is not described that the physical shape of a near-field light generating region of the thermal assist type magnetic head is inspected.

Moreover, Japanese Patent Application Laid-Open Publication No. 2002-277378 describes that the phase difference of the output signal is detected and the cantilever is always oscillated at a resonance frequency in the atomic force microscope. However, it is not described that the physical shape of the near-field light generating region of a thermal assist type magnetic head is inspected using information about the phase difference of the output signal.

Moreover, Japanese Patent Application Laid-Open Publication No. 2002-269708 describes that the phase difference in the oscillations of a probe is detected. However, it is not described that the physical shape of the near-field light generating region of a thermal assist type magnetic head is inspected.

The present invention is made in consideration of the problems above. The present invention is to provide a method for inspecting a thermal assist type magnetic head device and an apparatus therefor that can inspect the physical shape of a near-field light generating region of a thermal assist type magnetic head in an early stage in the midway point of the manufacturing process steps as early as possible.

In order to solve the problems above, the present invention is an inspection apparatus for a thermal assist type magnetic head device formed with a near-field light emitting portion, the apparatus including: a table unit on which a thermal assist type magnetic head device is placed, the table unit being movable in a plane, the thermal assist type magnetic head device being a sample; a cantilever including a probe to scan a surface of the sample placed on the table unit; an oscillation drive unit configured to vertically oscillate the cantilever with respect to the surface of the sample; a displacement detection unit configured to detect oscillations of the cantilever by applying light to a face opposite to a face on which the probe of the cantilever is formed and detecting reflected light from the cantilever, the cantilever being oscillated by the oscillation drive unit; a phase difference detection unit configured to detect a phase difference between a drive signal to vertically oscillate the cantilever by the oscillation drive unit and a detection signal obtained by detecting oscillations of the cantilever at the displacement detection unit; a phase difference image forming unit configured to form a phase difference image of the thermal assist type magnetic head device using information about the phase difference detected at the phase difference detection unit and positional information about the table unit; and a determining unit configured to determine quality of the near-field light emitting portion formed on the thermal assist type magnetic head device by processing the phase difference image formed at the phase difference image forming unit.

Moreover, in order to achieve the object, the present invention is a method for inspecting a thermal assist type magnetic head device formed with a near-field light emitting portion including the steps of: placing a thermal assist type magnetic head device on a table movable in a plane, the thermal assist type magnetic head device being a sample; scanning a surface of the sample placed on the table with a probe by vertically oscillating a cantilever including the probe over the surface of the sample while moving the table in a plane; detecting oscillations of the cantilever by applying light to a face opposite to a face on which the probe of the cantilever scanning the surface of the sample is formed and detecting reflected light from the cantilever; detecting a phase difference between a drive signal to vertically oscillate the cantilever and a detection signal obtained by detecting oscillations of the cantilever; and determining quality of the near-field light emitting portion formed on the thermal assist type magnetic head device using information about the detected phase difference.

In order to solve the problems above, the present invention is an inspection apparatus for inspecting a thermal assist type magnetic head device formed with a near-field light emitting portion, the apparatus including: a table unit on which a thermal assist type magnetic head device is placed, the table unit being movable in a plane, the thermal assist type magnetic head device being a sample; a cantilever including a probe to scan a plane apart at a constant distance from a surface of the sample placed on the table unit; a displacement detection unit configured to detect a displacement of the cantilever scanning the plane apart at a constant distance from the surface of the sample by applying light from a light projecting device to a face opposite to a face on which the probe of the cantilever is formed and detecting reflected light from the cantilever using a photodetector; an atomic force microscope (AFM) image forming unit configured to form an AFM image of the thermal assist type magnetic head device using a detection signal obtained by detecting the displacement of the cantilever at the displacement detection unit and positional information about the table unit; and a determining unit configured to determine quality of a physical shape including a size or typical dimensions of the near-field light emitting portion formed on the thermal assist type magnetic head device by processing the AFM image formed at the AFM image forming unit.

Furthermore, in order to solve the problems above, the present invention is a method for inspecting a thermal assist type magnetic head device formed with a near-field light emitting portion including the steps of: placing a thermal assist type magnetic head device on a table movable in a plane, the thermal assist type magnetic head device being a sample; scanning a plane apart at a constant distance from a surface of the sample placed on the table with a probe fixed to a cantilever while moving the table in a plane; detecting a displacement of the cantilever by applying light to a face opposite to a face on which the probe of the cantilever scanning the surface of the sample is formed and detecting reflected light from the cantilever; forming an atomic force microscope (AFM) image of the thermal assist type magnetic head device using information about the detected displacement of the cantilever and positional information about the table on which the thermal assist type magnetic head device being the sample is placed; and determining quality of a physical shape including a size or typical dimensions of the near-field light emitting portion formed on the thermal assist type magnetic head device by processing the formed AFM image of the thermal assist type magnetic head device.

According to the present invention, such an effect is exerted that the physical shape of a near-field light emitting portion of a thermal assist type magnetic head can be inspected in a nondestructive manner in an early stage in the midway point of the manufacturing process steps as early as possible.

These features and advantages of the invention will be apparent from the following more particular description of preferred embodiments of the invention, as illustrated in the accompanying drawings.

### BRIEF DESCRIPTION OF THE DRAWINGS

FIG. 1 is a block diagram of the schematic configuration of a thermal assist type magnetic head inspection apparatus according to a first embodiment;

FIG. 2 is an enlarged side view of a probe at the tip end portion of a cantilever and the thermally-assisted light generating portion of a recording head according to the first embodiment;

FIG. 3A is a graph of a drive waveform for oscillating the cantilever and a detected waveform signal obtained by detecting a reflection signal from the cantilever in the thermal assist type magnetic head inspection apparatus according to the first embodiment;

FIG. 3B is a graph of a drive waveform for oscillating the cantilever and a detected waveform signal obtained by detecting a reflection signal from the cantilever when a near-field light generating region is scanned in the thermal assist type magnetic head inspection apparatus according to the first embodiment;

FIG. 4A is a block diagram of the configuration of a control unit PC according to the first embodiment;

FIG. 4B is an image including a near-field light generating region and a magnetic field generating region of a thermal assist type magnetic head formed at a phase difference image forming unit according to the first embodiment;

FIG. 4C is an image including a near-field light generating region of the thermal assist type magnetic head formed at the phase difference image forming unit according to the first embodiment;

FIG. 5 is a flowchart of the operation procedures of the thermal assist type magnetic head inspection apparatus according to the first embodiment;

FIG. 6 is an enlarged side view of the cantilever in the state in which a relatively narrow small-gage wire is fixed to the tip end portion of the probe and the thermally-assisted light generating portion of the recording head in the thermal assist type magnetic head inspection apparatus according to the first embodiment;

FIG. 7 is a block diagram of the schematic configuration of a control unit PC of a thermal assist type magnetic head inspection apparatus according to an exemplary modification of the first embodiment;

FIG. 8 is a block diagram of the schematic configuration of a thermal assist type magnetic head inspection apparatus according to a second embodiment;

FIG. 9 is an enlarged side view of a cantilever including a probe having a magnetic film formed on the surface and the thermally-assisted light generating portion of a recording head according to the second embodiment;

FIG. 10 is a block diagram of the schematic configuration of a control unit PC of the thermal assist type magnetic head inspection apparatus according to the second embodiment;

FIG. 11 is a flowchart of the operation procedures of the thermal assist type magnetic head inspection apparatus according to the second embodiment;

FIG. 12 is an enlarged side view of a probe at the tip end portion of a cantilever and the thermally-assisted light generating portion of a recording head according to a third embodiment;

FIG. 13A is a graph of the relationship between the scan position of the probe on a thermal assist type magnetic head device and an output signal from a differential amplifier when the probe scans the surface of the thermal assist type magnetic head device at a certain gap d according to the third embodiment;

FIG. 13B is a graph that an output signal from the differential amplifier in FIG. 13A is binarized in the third embodiment;

FIG. 14A is a block diagram of the configuration of a control unit PC of a thermal assist type magnetic head inspection apparatus according to the third embodiment;

FIG. 14B is a diagram of an image of a thermal assist type magnetic head formed at an AFM image forming unit according to the third embodiment;

FIG. 15 is a front view of a screen on which inspection results are displayed on the thermal assist type magnetic head inspection apparatus according to the third embodiment;

FIG. 16 is a flowchart of an inspection flow of the thermal assist type magnetic head inspection apparatus according to the third embodiment;

FIG. 17 is an enlarged side view of the cantilever having a small-gage wire fixed to the tip end portion of the probe and the thermally-assisted light generating portion of the thermal assist type magnetic head according to the third embodiment;

FIG. 18 is an enlarged side view of a cantilever including a probe having a magnetic film formed on the surface and the thermally-assisted light generating portion of a recording head according to a fourth embodiment;

FIG. 19 is a graph of the relationship between the scan position of the probe on a thermal assist type magnetic head device and an output signal from a differential amplifier when the probe having a magnetic film formed on the surface scans the surface including the magnetic field generating region of the thermal assist type magnetic head device at a certain the gap d′ according to the fourth embodiment;

FIG. 20 is a block diagram of the configuration of a control unit PC of a thermal assist type magnetic head inspection apparatus according to the fourth embodiment; and

FIG. 21 is a flowchart of the operation procedures of the thermal assist type magnetic head inspection apparatus according to the fourth embodiment.

### DESCRIPTION OF THE PREFERRED EMBODIMENTS

For a method of inspecting the physical shape of a near-field light generating region (the size or typical dimensions of a near-field light generating region) of a thermal assist type magnetic head device, there are a method of inspecting a state of generating a near-field light generated in a near-field light emitting portion and a method of inspecting the physical shape of a near-field light generating region. In the present invention, it is made possible to detect the physical shape of a near-field light generating region of a thermal assist type magnetic head device using a scanning probe microscope.

In the following, embodiments of the present invention will be described in detail with reference to the drawings.

### First Embodiment

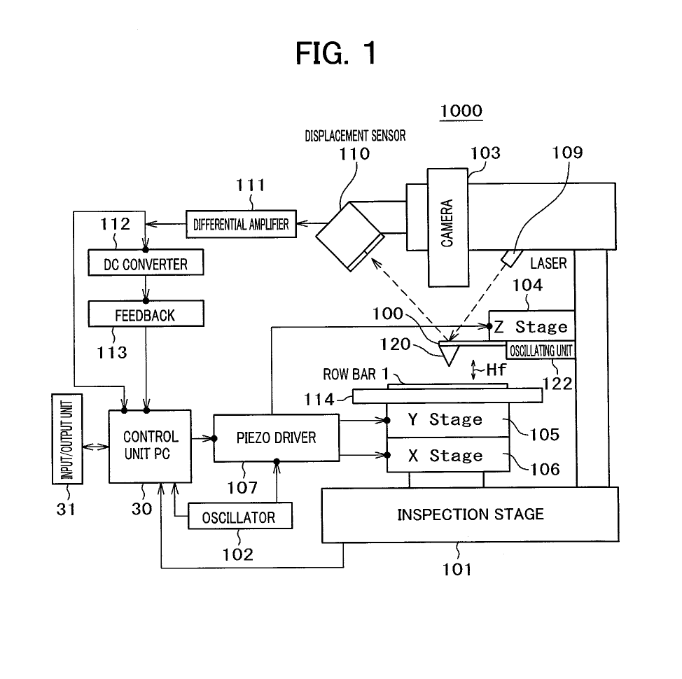

FIG. 1 is a block diagram of a basic configuration of a first embodiment of a thermal assist type magnetic head inspection apparatus according to the present invention. A thermal assist type magnetic head inspection apparatus in FIG. 1 can inspect the physical shape of a near-field light generating region of each of thermal assist type magnetic head devices 4 in a state of a row bar (a block of the thermal assist type magnetic head devices 4 arrayed) before the process step of cutting a single head slider (the thermal assist type magnetic head device 4). Generally, a row bar is cut out of a wafer as an elongated block in a length of about 3 to 5 cm, and is configured in which about 40 to 90 of the thermal assist type magnetic head devices 4 (head sliders) are arrayed. The thermal assist type magnetic head inspection apparatus according to the embodiment is configured to perform a predetermined inspection on the row bar 1 as a work. Generally, about 20 to 30 of the row bars 1 are arrayed and accommodated in a tray, not illustrated, in the direction of a minor axis at a predetermined gap. A handling robot, not illustrated, takes the row bar 1 out of the tray, not illustrated, one by one, and carries the row bar 1 to an inspection stage 101. The row bar 1 carried and placed on the inspection stage 101 is inspected as described later.

The inspection stage 101 includes an X stage 106 and a Y stage 105 that can move the row bar 1 in X- and Y-directions. The row bar 1 is positioned by bumping one side face of the row bar 1 in the direction of the major axis against the reference plane of the Y stage 105. A mounting unit 114 for positioning the row bar 1 is provided on the top face of the Y stage 105. A step (not illustrated) nearly matched with the shape of the row bar 1 is provided on the side edge of the top face of the mounting unit 114. The row bar 1 is disposed at a predetermined position by contacting the bottom face and side face of the step. The rear side face of the row bar 1 (a face opposite to a face on which the joining terminals of the thermal assist type magnetic head device 4 are provided) contacts the back face of the step. Since the contact surfaces each include a reference plane in the position relationship in which the contact surfaces are in parallel with and orthogonal to the moving direction (the X-axis) of the X stage 106 and the moving direction (the Z-axis) of a Z stage 104, the row bar 1 contacts the bottom face and side face of the step of the Y stage 105 for positioning the row bar 1 in the X- and Z-directions.

A camera 103 for measuring a position displacement amount is provided above the Y stage 105. The Z stage 104 moves a cantilever unit 100 of an atomic force microscope (AFM) in the Z-direction. The X stage 106, the Y stage 105, and the Z stage 104 of the inspection stage 101 are each configured of a piezo stage driven by a piezoelectric element. After finishing the positioning of the row bar 1 at a predetermined position, the row bar 1 is attached and held on the mounting unit 114.

A piezo driver 107 drives and controls the X stage 106, the Y stage 105, and the Z stage 104 (the piezo stages) of the inspection stage 101. A control unit PC 30 is configured of a control computer in the basic configuration of a personal computer (PC) including a monitor. As illustrated in FIG. 1, at a location opposite to the upper area of the row bar 1 placed on the mounting unit 114 on the Y stage 105 of the inspection stage 101, the cantilever unit 100 is disposed on which a probe 120 with a pointed tip end is formed and the end of the cantilever unit 100 is a free end. The cantilever unit 100 is mounted on an oscillating unit 122 provided on the lower side of the Z stage 104. The oscillating unit 122 is configured of a piezoelectric element, to which an alternating current voltage is applied at a frequency near a mechanical resonance frequency of the cantilever unit 100 caused by an excitation voltage from the piezo driver 107, and the probe 120 is vertically oscillated. Moreover, in the case where the excitation voltage from the piezo driver 107 is constant, the probe 120 is not oscillated, and stops at a certain position.

A displacement detecting unit is configured of a semiconductor laser device 109 and a displacement sensor 110 formed of a four divided optical detector device. A beam emitted from the semiconductor laser device 109 is applied on the cantilever unit 100, and a beam reflected off the cantilever unit 100 is guided to the displacement sensor 110. A differential amplifier 111 applies a predetermined arithmetic operation process to differential signals of four signals outputted from the displacement sensor 110, and outputs the signals to the DC converter 112. Namely, the differential amplifier 111 outputs displacement signals corresponding to differences between four signals outputted from the displacement sensor 110 to the DC converter 112. Therefore, in the state in which the cantilever unit 100 is not oscillated by the oscillating unit 122, the output from the differential amplifier 111 is zero. The DC converter 112 is configured of an RMS-DC converter (Root Mean Squared value to Direct Current Converter) that converts the displacement signal outputted from the differential amplifier 111 into a direct current signal of an effective value.

The displacement signal outputted from the differential amplifier 111 is a signal in response to the displacement of the cantilever unit 100. In the case where the cantilever unit 100 is oscillated, the signal is an alternating current signal, whereas in the case where the oscillations of the cantilever unit 100 are stopped, the signal is a direct current signal. The signal outputted from the DC converter 112 is inputted to a feedback controller 113. The feedback controller 113 outputs the signal inputted from the DC converter 112 to the control unit PC 30 as a signal to monitor the size of the present displacement amount of the cantilever unit 100. The signal is monitored at the control unit PC 30, and the piezoelectric element (not illustrated) to drive the Z stage 104 using the piezo driver 107 is controlled according to the value, so that the initial position of the cantilever unit 100 is adjusted before starting measurement. In the embodiment, the floating height of the head of a hard disk drive is set as the initial position of the cantilever unit 100.

An oscillator 102 is a device that supplies an oscillation signal to excite the cantilever unit 100 to the piezo driver 107. The piezo driver 107 drives the oscillating unit 122 based on the oscillation signal from the oscillator 102 to oscillate the cantilever unit 100 at a predetermined frequency. In the case where the probe 120 is not oscillated, the oscillator 102 does not output the oscillation signal to the piezo driver 107.

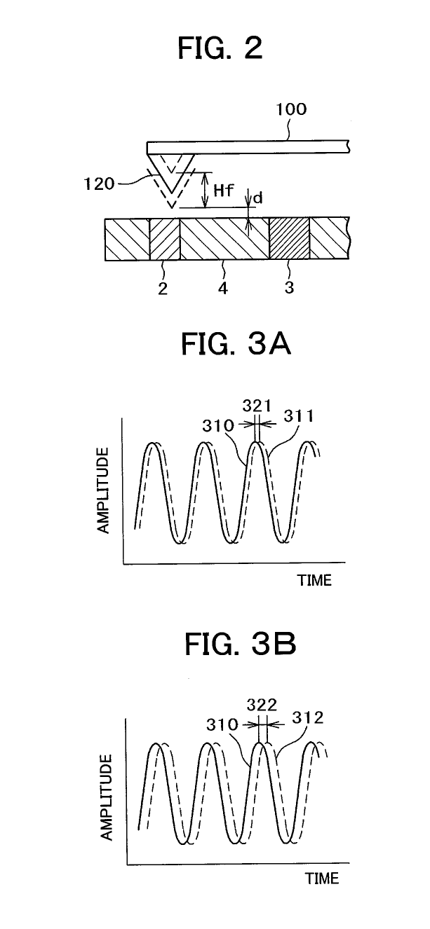

FIG. 2 is an enlarged diagram of the configuration of a magnetic field generating region 3 and a thermal assist light (a near-field light) generating region 2 of the thermal assist type magnetic head device 4 formed in the row bar 1 together with the cantilever unit 100.

As illustrated in FIG. 2, the cantilever unit 100 is positioned by the Z stage 104 in such a way that a constant gap d is maintained at the lowest point between the tip end portion of the probe 120 of the cantilever unit 100 and the surface of a sample on the surface of the thermal assist type magnetic head device 4 formed in the row bar 1 when the probe 120 is oscillated at a constant amplitude Hf. The cantilever unit 100 is oscillated by the piezo driver 107 receiving the oscillation signal from the oscillator 102 at the resonance frequency of the cantilever unit 100 or a frequency near the resonance frequency, and scans a plane in parallel with the recording surface of the thermal assist type magnetic head device 4 formed in the row bar 1 within a range of a few hundreds nm to a few μm. In the embodiment, the X stage 106 and the Y stage 107 move the row bar 1.

Here, in the case where the material of the row bar 1, which is a sample, is uniform in the range in which the probe 120 scans the row bar 1, as illustrated in FIG. 3A, a phase difference 321 between an oscillation waveform 310 of the cantilever unit 100 driven by the piezo driver 107 and a displacement signal waveform 311 is constant. The displacement signal waveform 311 is detected at the displacement sensor 110 by scanning the probe 120 over the plane in parallel with the recording surface of the thermal assist type magnetic head device 4.

However, when the scan range includes a portion having a material different from the materials of the other portions like the near-field light generating region 2 or the magnetic field generating region 3, force (van der Waals force) acting between the probe 120 and the portion having a different material is changed. As a result, as illustrated in FIG. 3B, even though the surface of the near-field light generating region 2 and the surface of the other portion are on the same plane in the scan range, the oscillation waveform of the cantilever unit 100 is changed, and a phase difference 322 between the oscillation waveform 310 of the cantilever unit 100 driven by the piezo driver 107 and a displacement signal waveform 312 detected at the displacement sensor 110 by scanning the probe 120 over the row bar 1 is changed with respect to the state in FIG. 3A.

In the change, although the amplitude Hf of the probe 120 is also fluctuated, the fluctuation is detected at the DC converter 112, and inputted to the control unit PC 30 through the feedback controller 113, and the control unit PC 30 controls the drive of the Z stage 104 by the piezo driver 107, so that the fluctuation of the amplitude Hf is suppressed.

The changed phase difference is imaged, so that the portion of the changed phase difference can be detected as a region of a different material. Positional information and size information about the region in which the detected phase difference is changed are compared with preset reference values using design information, and it is determined whether a difference from the reference value is in an acceptable range for inspecting whether the near-field light generating region 2 is correctly formed.

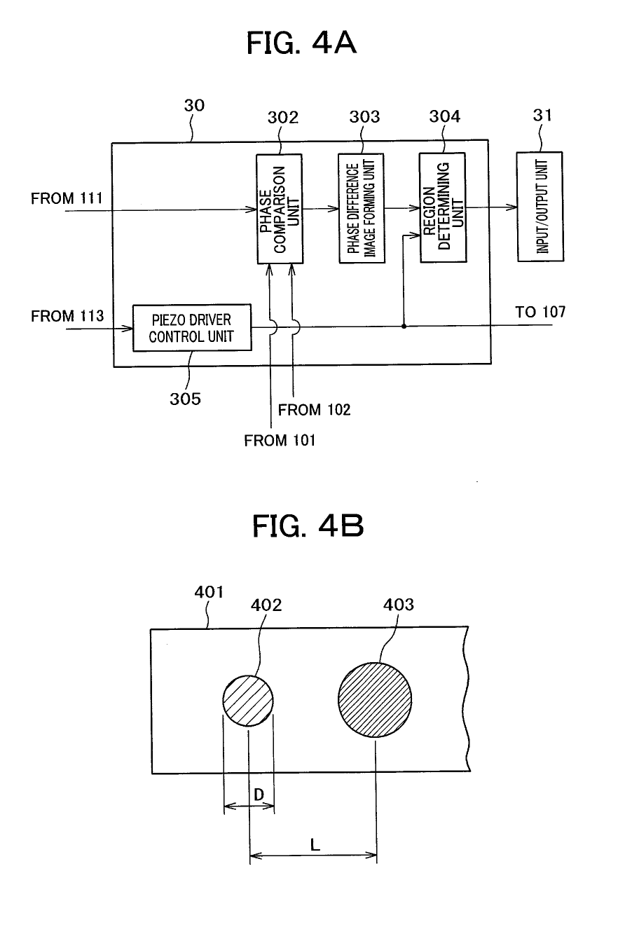

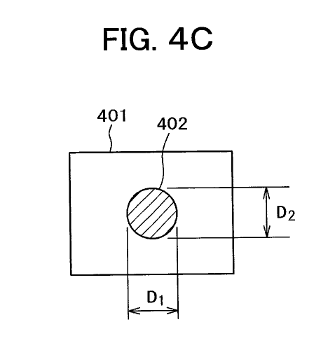

FIG. 4A is a diagram of the configuration of the control unit PC 30. A signal is inputted from the differential amplifier 111 in response to the displacement of the cantilever unit 100 (the signal 311 in FIG. 3A and the signal 312 in FIG. 3B), and the signal is inputted to a phase comparison unit 302. Moreover, the phase comparison unit 302 receives the signal transmitted from the oscillator 102 (the signal 310 in FIGS. 3A and 3B), and detects the phase difference between the signal from the oscillator 102 and the signal inputted from the differential amplifier 111. Subsequently, information about the detected phase difference is sent to a phase difference image forming unit 303 together with positional information about the Y stage 105 and the X stage 106 sent from the inspection stage 101, and a phase difference image 401 is formed as illustrated in FIG. 4B.

The formed phase difference image 401 is sent to a region determining unit 304, a gap L between the center of an image 402 of the near-field light generating region 2 and the center of an image 403 of the magnetic field generating region 3 and a size D of the image 402 of the near-field light generating region 2 are measured from the phase difference image 401, and the gap L and the size D are compared with preset reference values for calculating displacement amounts from the reference values. The calculated displacement amounts from the reference values are compared with preset thresholds. It is checked whether the displacement amounts are in acceptable ranges, and the quality of the position and shape of the near-field light generating region 2 is determined with reference to the magnetic field generating region 3. The determined result of quality is sent to an input/output unit 31, and displayed on a screen, not illustrated.

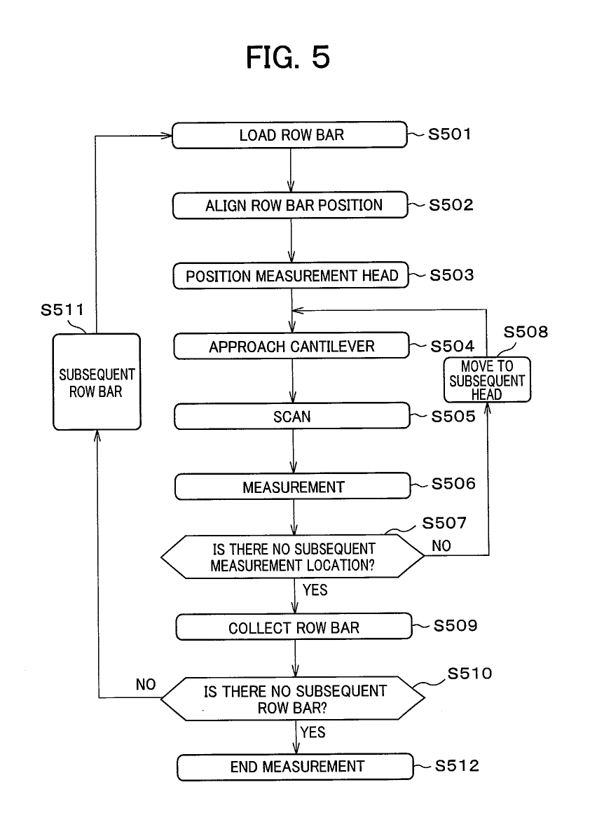

FIG. 5 is a flowchart of the operation procedures of the thermal assist type magnetic head inspection apparatus described above.

First, a row bar 1 is taken out of a plurality of the row bars 1 one by one and carried on the inspection stage 101 (S501), the row bar 1 is aligned using the camera 103 (S502), and the thermal assist type magnetic head device unit 4 (a measurement head) formed in the row bar 1 is moved at the measurement position for positioning the measurement head (the thermal assist type magnetic head device 4) (S503). Subsequently, the piezo driver 107 controls the Z stage 104, and the probe 120 of the cantilever unit 100 is approached to the recording surface of the measurement head (S504).

Subsequently, the piezo driver 107 drives the oscillating unit 122 based on the oscillation signal from the oscillator 102 to oscillate the cantilever unit 100 at a predetermined frequency. The piezo driver 107 drives the Y stage 105 and the X stage 106 to move the row bar 1 in the XY-plane in this state, and the cantilever unit 100 scans the plane in parallel with the recording surface of the head within a range of a few hundreds nm to a few μm (S505).

In the scanning, the oscillations of the cantilever 100 are detected as a signal waveform of a laser that is emitted from the semiconductor laser device 109, reflected off the cantilever 100, and detected at the displacement sensor 110. The detected signal waveform is compared with the drive signal waveform transmitted from the oscillator 102 to measure the phase difference (S506).

Subsequently, the cantilever is raised, and it is checked whether there is a head to be subsequently measured in the row bar 1 (S507). When there is a subsequent head, the head to be subsequently measured is moved on the lower part of the cantilever (S508), and manipulation from S504 is performed. In the case where there is no head to be subsequently measured in the row bar 1, the row bar 1 that measurement is finished is taken out using a handling unit, not illustrated, in the state in which the cantilever unit 100 is raised by the Z stage 104, and the row bar 1 is accommodated in a restoring tray (S509). Subsequently, it is checked whether there is an uninspected row bar 40 in a supply tray, not illustrated (S510). In the case where there is an uninspected row bar 40, the process is returned to S501, the uninspected row bar 40 is taken out from the supply tray (not illustrated) (S511), and the uninspected row bar 40 is carried to the inspection stage 101 for performing steps from S501. On the other hand, in the case where there is no uninspected row bar 40 in the supply tray, measurement is finished (S512).

It is noted that in the embodiment described above, it is described in which inspection is performed in the state of the row bar 1. However, the embodiment is not limited thereto. Such a configuration may be possible in which a single thermal assist type magnetic head device 4 cut out from the row bar 1 is placed on the mounting unit 114 for similar inspection as described above.

In the embodiment described above, a scheme is described in which the probe 120 is scanned in such a way that the probe 120 is avoided to directly contact the surface of the row bar 1, which is a sample. In this case, the lowest point for oscillations is a position at a constant distance apart from the surface of the row bar 1. However, such a scheme may be possible in which the lowest point of the oscillations of the probe 120 is matched with the surface of the row bar 1 for scanning while contacting the row bar 1 at the lowest point for oscillations.

Moreover, in the embodiment described above, a method is described in which the phase difference image between the region including the near-field light generating region 2 and the region including the magnetic field generating region 3 of the thermal assist type magnetic head device 4 is formed, and the gap L between the center of the image 402 of the near-field light generating region 2 and the center of the image 403 of the magnetic field generating region 3 and the size D of the image 402 of the near-field light generating region 2 are found to determine the quality of the position and shape of the near-field light generating region 2. However, such a configuration may be possible in which the region including the magnetic field generating region 3 is not scanned with the probe 120, only the scan region including the near-field light generating region 2 is scanned with the probe 120 using design information about the thermal assist type magnetic head device 4, the phase difference image of the region including the near-field light generating region 2 is formed, dimensions D1 and D2 in two directions orthogonal to each other are found from the phase difference image 402 of the near-field light generating region 2 as illustrated in FIG. 4C, and the dimensions D1 and D2 are compared with preset reference values for determining the quality of the shape of the near-field light generating region 2.

According to the embodiment, the near-field light generating region of the thermal assist type magnetic head device can be inspected without emitting a near-field light in a relatively early stage of the manufacturing process steps of the thermal assist type magnetic head device, in a row bar state, for example. Moreover, it is unnecessary to equip a mechanism to emit a near-field light on the inspection apparatus, so that the configuration of the inspection apparatus can be relatively simplified.

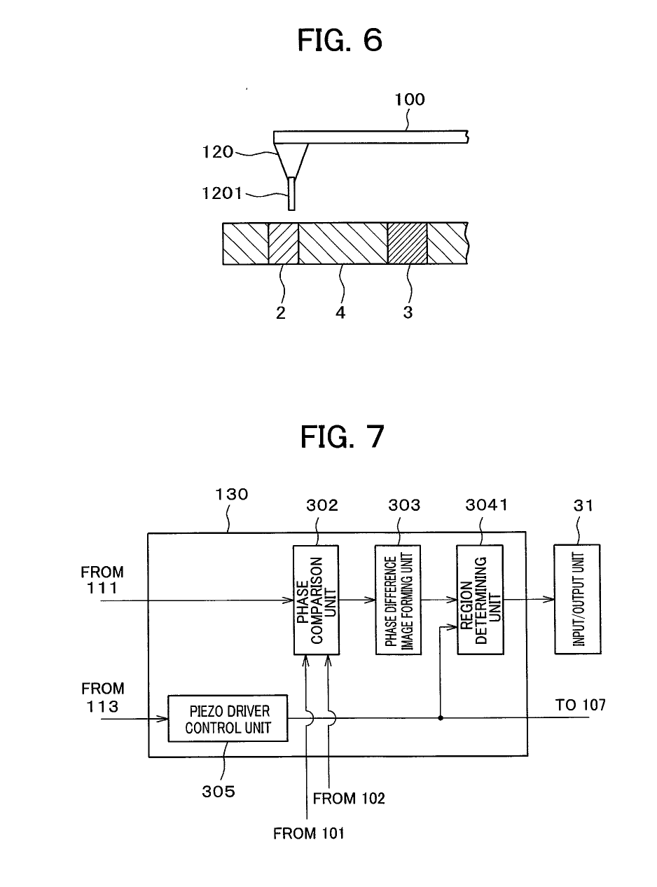

In the embodiment described above, as illustrated in FIG. 2, the configuration is described in which the probe 120 scans the surface of the row bar 1, which is a sample. However, such a configuration may be possible in which as illustrated in FIG. 6, a small-gage wire 1201 of a relatively hard material is fixed to the tip end portion of the probe 120 and the surface of the row bar 1 is scanned using the small-gage wire 1201. For a material forming the small-gage wire 1201, any one of carbon nanofiber (CNF), a carbon nanotube (CNT), a high density carbon (HDC:DLC), and tungsten (W) may be used. With this configuration, the small-gage wire 1201 of a relatively hard material contacts the thermal assist type magnetic head device 4 formed in the row bar 1, and the lifetime of the cantilever 100 can be prolonged more than in the case where the probe 120 is directly contacted.

### Exemplary Modification

In the first embodiment, it is described in which the control unit PC 30 creates a phase difference image using the output of the differential amplifier 111. In this exemplary modification, an amplitude control signal from the feedback controller 113 for the Z stage 104 is also used.

The feedback controller 113 receives the output from the differential amplifier 111 to detect the fluctuation of the amplitude of the cantilever 100, and outputs a signal to suppress the fluctuation of oscillations.

The fluctuation of oscillations is generated because the material of the thermal assist type magnetic head device 4 is changed in scanning the probe 120 to cause a change in the amplitude of the oscillations of the cantilever 100. The fluctuation of oscillations includes positional information about the boundary of the material of the thermal assist type magnetic head device 4.

In the exemplary modification, as illustrated in FIG. 7, the control unit PC 30 described in the first embodiment is replaced by a control unit PC 130. In the control unit PC 130, a piezo driver control unit 305 receives an output signal including the information from the differential amplifier 111, branches a signal outputted to the piezo driver 107 to control the Z stage 104, and inputs the signal to a region determining unit 3041.

The region determining unit 3041 receives the output from the differential amplifier 111 and the signal from the oscillator 102 to identify the boundary between the image 402 of the near-field light generating region 2 and the image 403 of the magnetic field generating region 3 from the phase difference image 401 illustrated in FIG. 4B, using a phase difference image formed at the phase difference image forming unit 303 with phase difference information extracted at the phase comparison unit 302 and the control signal for the Z stage 104 including positional information about the boundary of the material of the thermal assist type magnetic head device 4 outputted from the piezo driver control unit 305. The center and width of the image 402 corresponding to the near-field light generating region 2 and the center of the image 403 corresponding to the magnetic field generating region 3 are then found from information about the identified boundary, and the gap L between the center of the image 402 and the center of the image 403 and a width D of the image 402 are calculated. The gap L and the width D are compared with preset reference values, and displacement amounts from the reference values are calculated. The calculated displacement amounts from the reference values are then compared with preset thresholds, and it is checked whether the displacement amounts are in acceptable ranges. The quality of the position and size of the near-field light generating region 2 with reference to the magnetic field generating region 3 is determined based on the result. The determined result of the quality is sent to the input/output unit 31, and displayed on a screen, not illustrated.

According to the exemplary modification, the region of the image 402 corresponding to the near-field light generating region 2 and the region of the image 403 corresponding to the magnetic field generating region 3 can be determined using a plurality of items of information, so that the quality of the position and size of the near-field light generating region 2 can be determined at higher accuracy.

### Second Embodiment

A second embodiment of the present invention will be described with reference to the drawings.

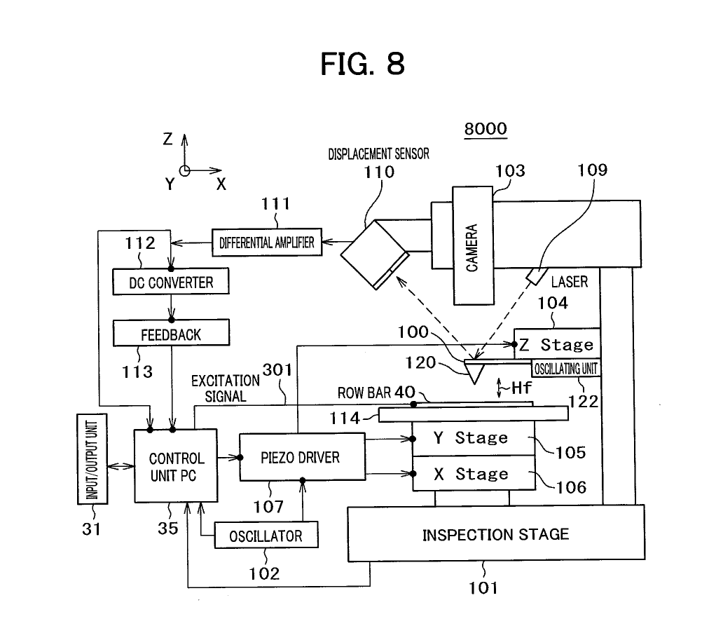

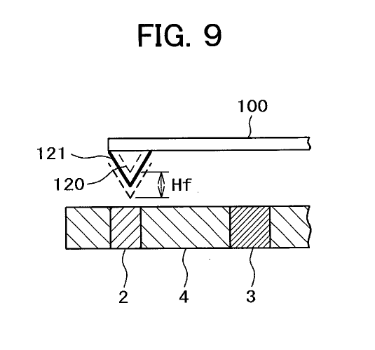

FIG. 8 is a diagram of the configuration of a thermal assist type magnetic head inspection apparatus 8000 according to the embodiment. A basic configuration of the thermal assist type magnetic head inspection apparatus 8000 according to the embodiment is basically similar to the configuration of the apparatus according to the first embodiment illustrated in FIG. 1. As expressed by a thick line of a cantilever 100 in FIG. 9, the embodiment is different in that a magnetic film 121 is formed on the surface of a probe 120 of the cantilever 100. Moreover, the embodiment is different in that an excitation signal output unit 1007 is provided on a control unit PC 35 and a signal line 301 is additionally provided to send a signal to a thermal assist type magnetic head device unit 4 formed in a row bar 1. The signal is outputted from the excitation signal output unit 1007, and generates a magnetic field on a magnetic field generating region 3 of the thermal assist type magnetic head device unit 4.

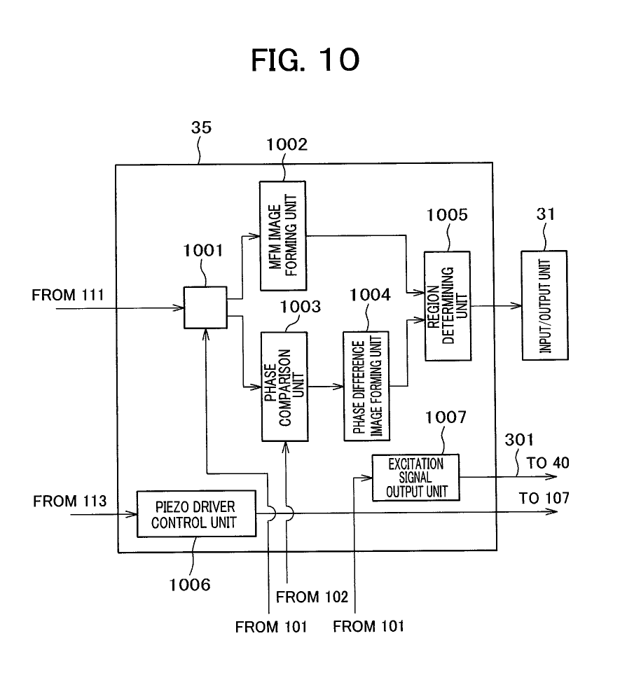

FIG. 10 is a diagram of the configuration of the control unit PC 35 according to the embodiment. The control unit PC 35 is different from the control unit PC 30 according to the first embodiment in that the control unit PC 35 includes a signal switching circuit unit 1001 that switches a signal outputted from a differential amplifier 111 between an MFM image generating unit 1002 and a phase comparison unit 1003 and the MFM image generating unit 1002 that processes the signal outputted from the differential amplifier 111 and creates an MFM (Magnetic Force Microscope) image when a region including the magnetic field generating region 3 is scanned while oscillating the probe 120 of the cantilever 100 formed with the magnetic film 121 on the surface.

The signal switching circuit unit 1001 outputs the signal outputted from the differential amplifier 111 to the MFM image generating unit 1002 side together with positional information about an X stage 106 and a Y stage 105 outputted from an inspection stage 101 based on positional information about the X stage 106 and the Y stage 105 outputted from the inspection stage 101 when the probe 120 is scanning a region including the magnetic field generating region 3 of the thermal assist type magnetic head device unit 4. The MFM image generating unit 1002 forms an MFM image using the signal from the differential amplifier 111 and positional information about the X stage 106 and the Y stage 105 outputted from the inspection stage 101.

On the other hand, the signal switching circuit unit 1001 outputs the signal outputted from the differential amplifier 111 to the phase comparison unit 1003 side together with positional information about the X stage 106 and the Y stage 105 outputted from the inspection stage 101 when the probe 120 is scanning a region including the near-field light generating region 2 of the thermal assist type magnetic head device unit 4. Since signal processing in the phase comparison unit 1003 and a phase difference image forming unit 1004 is similar to processing in the control unit PC 30 described in the first embodiment, the description is omitted.

The region determining unit 1005 receives the MFM image formed at the MFM image generating unit 1002 and a phase difference image formed at the phase difference image forming unit 1004, and determines the quality of the position and size of the optical near field generating region 2 with reference to the magnetic field generating region 3.

The excitation signal output unit 1007 sends a magnetic field generating signal to the magnetic field generating region 3 through the signal line 301 based on positional information about the X stage 106 and the Y stage 105 outputted from the inspection stage 101 when the probe 120 scans the region including the magnetic field generating region 3 of the thermal assist type magnetic head device unit 4.

A piezo driver control unit 1006 receives the output signal from the differential amplifier 111, and outputs a signal to control a Z stage 104 to a piezo driver 107.

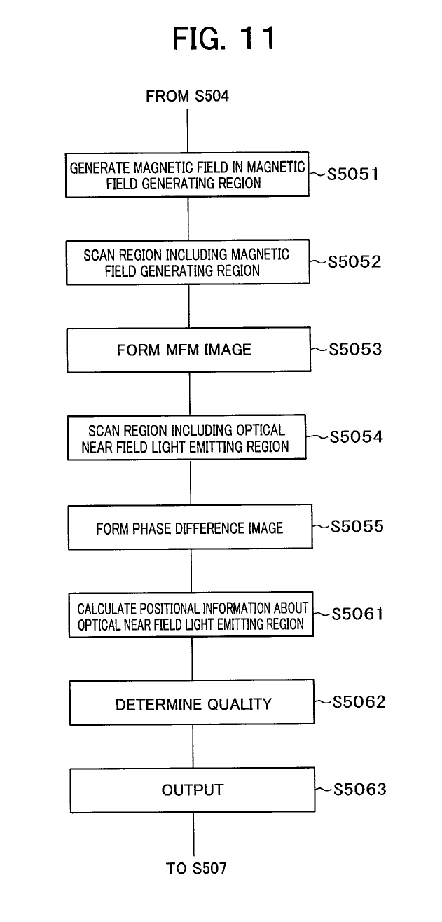

The operation procedures of the thermal assist type magnetic head inspection apparatus 8000 according to the present embodiment are the same as the operation procedures described in the first embodiment with reference to FIG. 5 except S506 and S507. Portions different from the portions of the flowchart of the first embodiment illustrated in FIG. 5 will be described with reference to FIG. 11.

After completion in S504, the excitation signal output unit 1007 receives positional information about the X stage 106 and the Y stage 105 output from the inspection stage 101, outputs a signal to generate a magnetic field on the magnetic field generating region 3 of the thermal assist type magnetic head device unit 4 formed in the row bar 1 through the signal line 301, and generates a magnetic field on the magnetic field generating region 3 (S5051). Subsequently, the region including the magnetic field generating region 3 on which a magnetic field is generated is scanned while vertically oscillating the probe 120 of the cantilever 100 formed with the magnetic film 121 on the surface (S5052), and an MFM image of the magnetic field generating region 3 is created at the MFM image forming unit 1002 (S5053).

Subsequently, the signal to generate a magnetic field on the magnetic field generating region 3 of the thermal assist type magnetic head device unit 4 formed in the row bar 1 from the signal line 301 is interrupted, the probe 120 scans the region including the near-field light generating region 2 while vertically oscillating the cantilever 100 as similar to the case of the first embodiment (S5054), and a phase difference image of the region including the near-field light generating region 2 is formed at the phase difference image forming unit 1004 (S5055). Moreover, the phase difference image and the MFM image created in S5052 are used to identify the positions of the magnetic field generating region 3 and the near-field light generating region 2, a distance from the magnetic field generating region 3 to the near-field light generating region 2 is calculated as positional information about the near-field light generating region 2, and the size of the near-field light generating region 2 is calculated from the phase difference image (S5061). Lastly, the calculated values are compared with preset reference values to determine the quality of the position and size of the near-field light generating region 2 (S5062), and the result is outputted to an input/output unit 31 together with the MFM image and the phase difference image (S5063).

Also in the embodiment, as similar to the description in the first embodiment, such a configuration may be possible in which as illustrated in FIG. 6, the tip end portion of the probe 120 includes a small-gage wire of a relatively hard material formed with a magnetic film on the surface and the surface of the row bar 1 is scanned using the small-gage wire formed with the magnetic film on the surface. For a material forming the small-gage wire 1201, any one of carbon nanofiber (CNF), a carbon nanotube (CNT), a high density carbon (HDC:DLC), and tungsten (W) may be used. With this configuration, the small-gage wire 1201 of a relatively hard material contacts the thermal assist type magnetic head device 4 formed in the row bar 1, and the lifetime of the cantilever 100 can be prolonged more than in the case where the probe 120 is directly contacted.

### Third Embodiment

This embodiment relates to a method of inspecting a thermal assist type magnetic head device formed with a near-field light emitting portion by scanning a cantilever in a plane at a constant distance apart from the surface of a sample without contacting the cantilever with the sample and an apparatus therefor.

Since the configuration of the thermal assist type magnetic head inspection apparatus according to the embodiment is similar to the configuration described in the first embodiment in FIG. 1, the detailed descriptions are omitted.

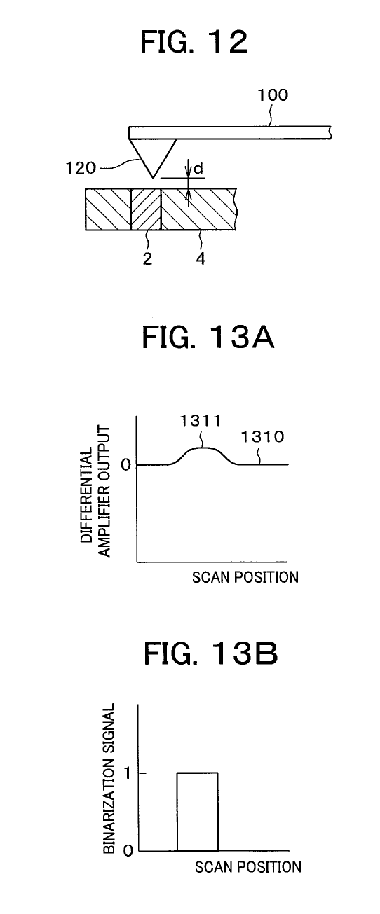

FIG. 12 is an enlarged diagram of the configuration of a thermal assist light (a near-field light) generating region 2 of a thermal assist type magnetic head device 4 formed in a row bar 1 together with a cantilever unit 100.

In the embodiment, as illustrated in FIG. 12, the cantilever unit 100 is controlled by a Z stage 104, and stationary with respect to the surface of the thermal assist type magnetic head device 4 formed in the row bar 1 in such a way that a constant gap d is maintained between the tip end portion of a probe 120 of the cantilever unit 100 and the surface of the thermal assist type magnetic head device 4. In this state, a piezo driver 107 receives an oscillation signal from an oscillator 102, and controls an X stage 106 and a Y stage 105 to move the row bar 1 in a plane, so that the probe 120 mounted at the tip end portion of the cantilever unit 100 scans a desired region of the row bar 1 in a range of a few hundreds nm to a few μm.

Here, in the case where the probe 120 scans a location where a material is uniform in the scan range on the surface of the thermal assist type magnetic head device 4 formed in the row bar 1, which is a sample, the output of a differential amplifier is zero as illustrated in an output waveform 1310 of the differential amplifier in FIG. 13A. Namely, the probe 120 is in an attitude in which the probe 120 scans a plane apart at a constant distance from the surface of the thermal assist type magnetic head device 4. In contrast to this, when the scan range includes a portion having a material different from the materials of the other portions like the near-field light generating region 2, force (van der Waals force) acting between the probe 120 and the portion having a different material is changed. As a result, the cantilever unit 100 is displaced to change the position of reflected light from the cantilever unit 100, the light enters a displacement sensor 110, and the displacement signal waveform 1310 outputted from the displacement sensor 110 is changed as a signal level 1311 illustrated in FIG. 13A.

The changed displacement signal waveform 1310 is imaged using positional information about the X stage 106 and the Y stage 105, so that a portion in which the cantilever unit 100 is displaced can be detected as a region of a different material. From the detected image, information about the position and size of the region in which the cantilever unit 100 is displaced can be obtained. This information is then compared with a preset reference value using design information to determine whether a difference from the reference value is in an acceptable range, so that it can be inspected whether the optical near field generating region 2 is correctly formed.

Since the position of the near-field light generating region 2 from the end surface of the row bar 1 can be estimated from design information for the near-field light generating region 2 the thermal assist type magnetic head device 4 formed in the row bar 1, which is an inspection target, information about a region including the near-field light generating region 2 can be surely acquired by an AFM when the region including the near-field light generating region 2 is set to the scan region of the probe 120 in consideration of errors.

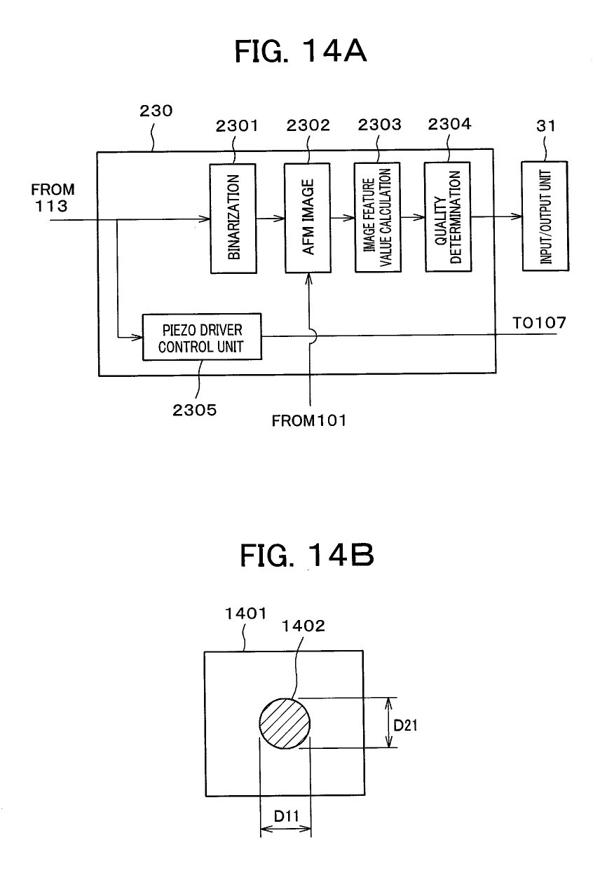

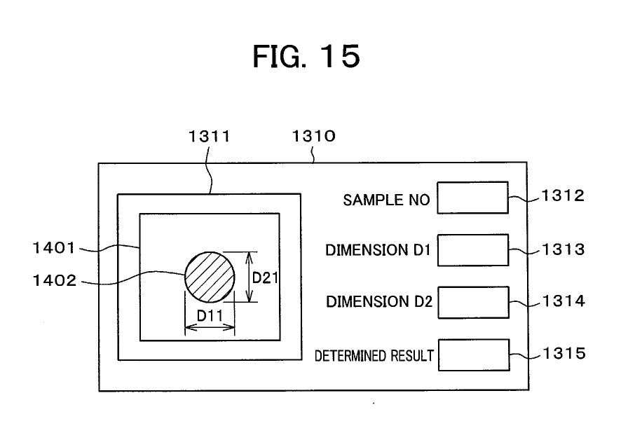

FIG. 14A is a diagram of the configuration of a control unit PC 30. The control unit PC 30 receives a signal from a feedback controller 113. The signal from the feedback controller 113 is a signal in which an AC output from a differential amplifier 111 received with a signal from the displacement sensor 110 is converted into a DC signal at a DC converter 112.

The control unit PC 30 according to the embodiment includes a binarization processing unit 1301, an AFM image forming unit 1302, an image feature value calculating unit 1303, and a quality determining unit 1304. A determined result at the quality determining unit 1304 is outputted to an input/output unit 31. The control unit PC 30 further includes a piezo driver control unit 1305 that receives the signal from the feedback controller 113 to control the piezo driver 107.

The signal inputted from the feedback controller 113 to the control unit PC 30 is formed into a binarized signal waveform at the binarization processing unit 1301 as illustrated in FIG. 13B with reference to a preset threshold.

The binarized signal is received at the AFM image forming unit 1302, and stored across the region scanned by the probe 120 for processing, so that a binarized AFM image 1401 including a region 1402 corresponding to the near-field light generating region 2 on the surface of the thermal assist type magnetic head device 4 can be obtained.

Subsequently, the binarized AFM image 1401 is sent to the image feature value calculating unit 1304, and an image feature value is calculated. In the example in FIG. 14B, dimensions D11 and D21 are calculated. The dimensions D11 and D21 are in two directions orthogonal to each other in the region 1402, which is the feature region of the binarized image 1401.

The items of information about the calculated dimensions D11 and D21 are sent to the quality determining unit 1304 for comparison with preset quality determining reference values, and the quality of the size of the near-field light generating region 2 corresponding to the region 1402 on the AFM image 1401 is determined.

The determined result is outputted to the input/output unit 31, and the binarized image 1401 including the region 1402 corresponding to the near-field light generating region 2 is displayed on an image display region 1311 of a display screen 1310 of the input/output unit 31. Moreover, a sample number display portion 1312 on which a sample number displayed on the image display region 1311 is displayed. A dimension D11 and a dimension D21 for the region 1402 calculated at the image feature value calculating unit 1304 are displayed on a portion 1313 and a portion 1314, respectively, on the screen 1310. A result determined at the quality determining unit 1304 is displayed on a determined result display portion 1315.

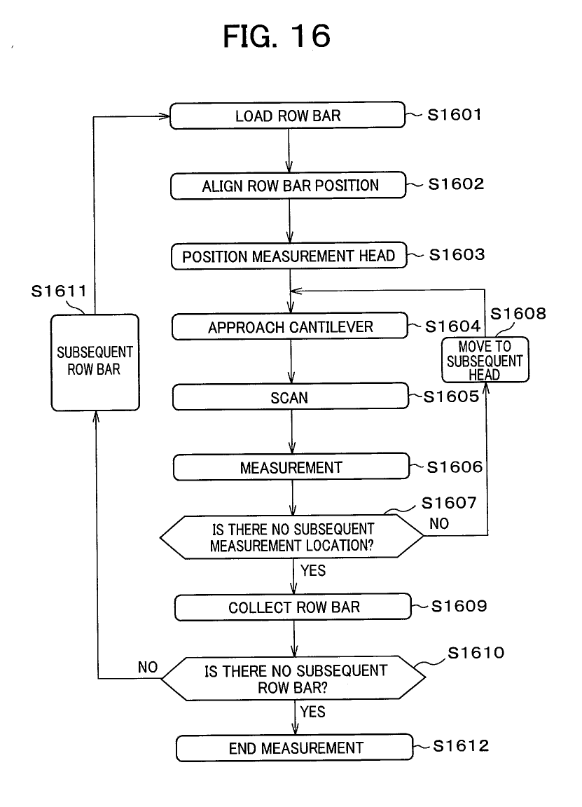

FIG. 16 is a flowchart of the operation procedures of the thermal assist type magnetic head inspection apparatus described above.

First, the row bar 1 is taken out of a plurality of the row bars 1 one by one and carried on the inspection stage (S1601), the row bar 1 is aligned using a camera 103 (S1602), and the thermal assist type magnetic head device unit 4 (the measurement head) formed in the row bar 1 is moved at the measurement position for positioning the measurement head (the thermal assist type magnetic head device 4) (S1603). Subsequently, the piezo driver 107 controls the Z stage 104 to approach the probe 120 of the cantilever unit 100 to the recording surface of the measurement head (S1604). Subsequently, in the state in which the cantilever unit 100 is fixed, the piezo driver 107 drives the Y stage 105 and the X stage 106 to move the row bar 1 in the XY-plane, and the cantilever unit 100 scans the plane in parallel with the recording surface of the head within a range of a few hundreds nm to a few μm (S1605).

In the scanning, the displacement of the cantilever 100 is detected as position displacement of a laser on four divided detection surfaces of the displacement sensor 110. The laser is emitted from a semiconductor laser device 109 and reflected off the cantilever 100. The differential amplifier 111 converts the detection signal from the displacement sensor 110, which detects the laser, into signals on the four divided detection surfaces of the displacement sensor 110 according to quantities of light received, and the signals are converted into digital signals at the DC converter 112, and inputted to the control unit PC 30 through the feedback controller 113. The signals inputted to the control unit PC 30 are processed according to the procedures described with reference to FIG. 14A previously, and the quality of the physical shape of the near-field light generating region 2 is determined (S1606).

Subsequently, when finishing the scanning of the probe 120 over a predetermined region of the thermal assist type magnetic head device unit 4, the cantilever is raised, and it is checked whether there is a head to be subsequently measured in the row bar 1 (S1607). When there is a subsequent head, the head to be subsequently measured is moved on the lower part of the cantilever (S1608), and manipulations from S1604 are performed. In the case where there is no head to be subsequently measured in the row bar 1, in the state in which the cantilever unit 100 is raised by the Z stage 104, the row bar 1 that measurement is finished is taken out using a handling unit, not illustrated, and the row bar 1 is accommodated in a restore tray (S1609). Subsequently, it is checked whether there is an uninspected row bar 40 on a supply tray, not illustrated (S1610). In the case where there is an uninspected row bar 40, the process is returned to S1601, the uninspected row bar 40 is taken out of the supply tray (not illustrated) (S1611), and the uninspected row bar 40 is carried to the inspection stage 101 for performing steps from S1601. On the other hand, in the case where there is no uninspected row bar 40 in the supply tray, measurement is finished (S1612).

It is noted that in the embodiment described above, it is described in which inspection is performed in the state of the row bar 1. However, the embodiment is not limited thereto. Such a configuration may be possible in which a single slider (the thermal assist type magnetic head device 4) cut out from the row bar 1 is placed on a mounting unit 114 for similar inspection as described above.

According to the embodiment, the near-field light generating region of the thermal assist type magnetic head device can be inspected without emitting an near-field light in a relatively early stage of the manufacturing process steps of the thermal assist type magnetic head device, in a row bar state, for example. Moreover, it is unnecessary to equip a mechanism to emit a near-field light on the inspection apparatus, so that the configuration of the inspection apparatus can be relatively simplified.

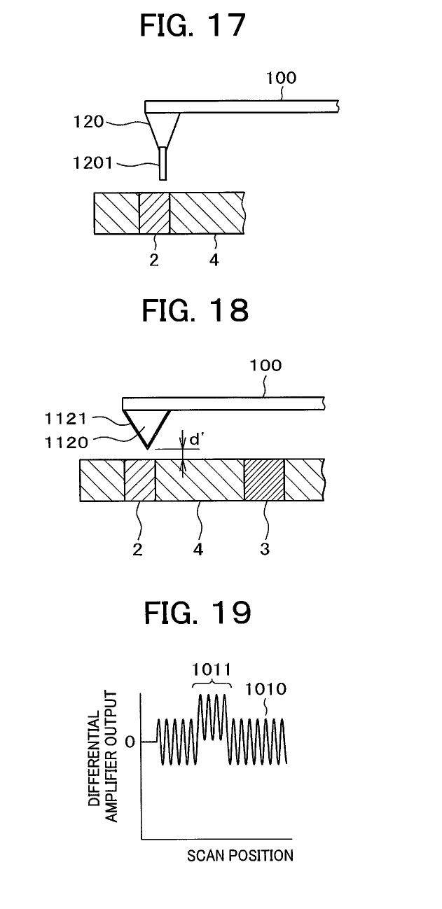

In the embodiment described above, as illustrated in FIG. 12, the configuration is described in which the probe 120 scans the surface of the row bar 1, which is a sample. However, such a configuration may be possible in which as illustrated in FIG. 17, a small-gage wire 1201 of a relatively hard material is fixed to the tip end portion of the probe 120 and the surface of the row bar 1 is scanned using the small-gage wire. For a material forming the small-gage wire 1201, any one of carbon nanofiber (CNF), a carbon nanotube (CNT), a high density carbon (HDC:DLC), and tungsten (W) may be used. With this configuration, the small-gage wire 1201 of a relatively hard material contacts the thermal assist type magnetic head device 4 formed in the row bar 1, and the lifetime of the cantilever 100 can be prolonged more than in the case where the probe 120 is directly contacted.

### Fourth Embodiment

A fourth embodiment of the present invention will be described with reference to the drawings.

The embodiment is different from the third embodiment in that before acquiring an AFM image of a region including a near-field light generating region 2 of a thermal assist type magnetic head device unit 4, a magnetic field is generated on a magnetic field generating region 3, and an MFM image of the region including the magnetic field generating region 3 is acquired. The position of the magnetic field generating region 3 is identified from the acquired MFM image of the region including the magnetic field generating region 3, design information is used to locate a position on the near-field light generating region 2 with reference to the position of the magnetic field generating region 3, and the region including the near-field light generating region 2 can be reliably scanned by a probe 120.

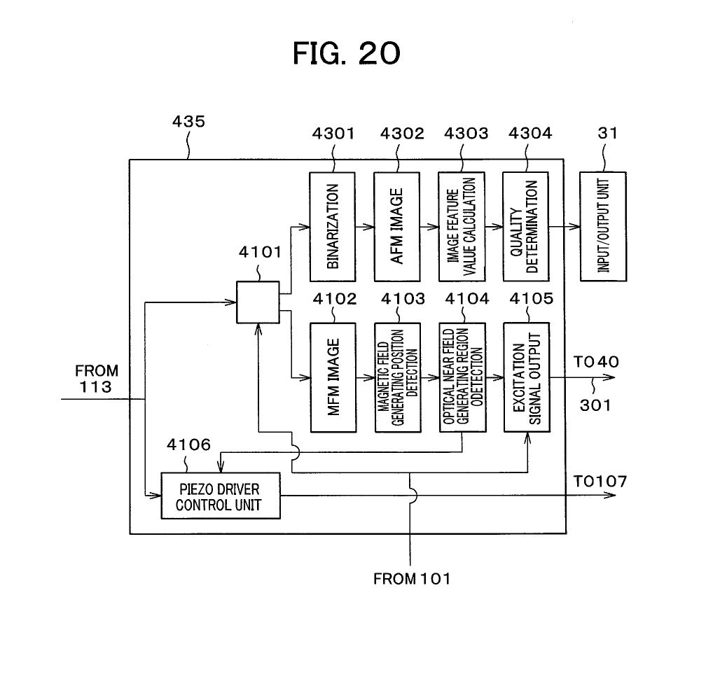

Since the configuration of a thermal assist type magnetic head inspection apparatus according to the embodiment is the same as the configuration of the thermal assist type magnetic head inspection apparatus 8000 according to the second embodiment described with reference to FIG. 8, except that the control unit PC 35 is replaced by a control unit PC 435 illustrated in FIG. 20, the description of the same part is omitted.

A basic configuration of a thermal assist type magnetic head inspection apparatus 8000 according to the present embodiment is basically similar to the configurations of the apparatuses according to the first embodiment in FIG. 1 and the third embodiment. However, as illustrated in FIG. 18, the configuration is different in that a magnetic film 1121 expressed by a thick line is formed on the surface of a probe 1120 of a cantilever 100. Moreover, the configuration according to the present embodiment is different from the configurations according to the first embodiment and the third embodiment in that the control unit PC 435 includes an excitation signal output unit 4105 as similar to the second embodiment and that a signal line 301 is additionally provided to send a signal, which is outputted from the excitation signal output unit 4105 and generates a magnetic field on the magnetic field generating region 3 of the thermal assist type magnetic head device unit 4, to the thermal assist type magnetic head device unit 4 formed in a row bar 1 as similar to the case of the second embodiment.

In the embodiment, first, the cantilever 100 is oscillated in the state in which a magnetic field is generated on the magnetic field generating region 3 of the thermal assist type magnetic head device unit 4, an MFM image is acquired by scanning the region including the magnetic field generating region 3 with the probe 1120, and the magnetic field generating region 3 is identified from the MFM image. Subsequently, the position of the near-field light generating region 2 is found from design information with reference to the position of the identified magnetic field generating region 3. Subsequently, the probe 1120 scans the region including the found near-field light generating region 2 while maintaining a constant gap d′ between the tip end portion of the probe 1120 and the surface of the thermal assist type magnetic head device unit 4 in the state in which the oscillations of the cantilever 100 are stopped, and then an AFM image of the region including the near-field light generating region 2 is acquired. The near-field light generating region 2 is then identified from the AFM image, and the quality of the physical shape including the size or typical dimensions of the near-field light generating region 2 is determined.

In the embodiment, in the case where the region including the magnetic field generating region 3 is scanned, a Z stage 104 controls the position in the Z-direction of the cantilever 100 oscillated by an oscillating unit 122. Namely, the probe 1120 is oscillated in such a way that the constant gap d′ is maintained at the lowest end between the tip end portion of the probe 1120 formed with the magnetic film 1121 on the surface of the cantilever 100 and the surface of the thermal assist type magnetic head device 4 formed in the row bar 1. In this state, a piezo driver 107 receives an oscillation signal from an oscillator 102, and controls an X stage 106 and a Y stage 105 to move the row bar 1 in a plane, so that the probe 1120 mounted on the tip end portion of the cantilever 100 scans a desired region of the row bar 1 in a range of a few hundreds nm to a few μm.

Here, in the case where the probe 1120 scans a location where a material is uniform in the scan range and no magnetic field is generated on the surface of the thermal assist type magnetic head device 4 formed in the row bar 1, which is a sample, the output of a differential amplifier is a waveform oscillated around zero as illustrated in an output waveform 1010 of a differential amplifier 111 in FIG. 19. In contrast to this, when a magnetic field is generated from the magnetic field generating region 3 in the scan range, the magnetic film 1121 formed on the surface of the probe 1120 is affected by the effect of the magnetic field, and attracted to the magnetic field generating region 3. As a result, the center of the oscillations of the cantilever 100 is displaced, the center position of the oscillations of light incident to the displacement sensor 110 which is reflected from the cantilever 100 is changed, and the output waveform from the differential amplifier 111 is changed as illustrated in a displacement signal waveform 1011.

The displacement signal waveform 1010 thus changed is imaged using positional information about the X stage 106 and the Y stage 105 at the control unit PC 435, so that a portion in which the center of the oscillations of the cantilever 100 is changed from a zero output of the differential amplifier can be detected as the magnetic field generating region 3. Positional information about the detected magnetic field generating region 3 is then compared with design information stored in advance, so that the position of the near-field light generating region 2 on the X stage 106 and the Y stage 105 can be calculated. Thus, it is made possible that the X stage 106 and the Y stage 105 are controlled to reliably capture the near-field light generating region 2 in the visual field of an AFM.

FIG. 20 is a diagram of the configuration of the control unit PC 435 according to the embodiment. The control unit PC 435 according to the embodiment includes a signal switching circuit unit 4101 that switches a signal outputted from a DC converter 112 through a feedback controller 113 between an MFM image generating unit 4102 and a binarization circuit unit 4301. Moreover, the control unit PC 435 further controls the probe 1120 of the cantilever 100 in such a way that the lowest point for oscillations is at the constant height with respect to the surface of the thermal assist type magnetic head device unit 4 in the state in which the probe 1120 of the cantilever 100 is oscillated. The probe 1120 is formed with the magnetic film 1121 on the surface. The control unit PC 435 includes the MFM image generating unit 4102 that processes the signal outputted from the differential amplifier 111 to create an MFM (Magnetic Force Microscope) image when the region including the magnetic field generating region 3 is scanned in this state. These points are different from the control unit PC 30 according to the first embodiment and the third embodiment.

The control unit PC 435 according to the embodiment further includes an AFM image generating unit 4302, an image feature value calculating unit 4303, a quality determining unit 4304, a magnetic field generating position detecting unit 4103, a near-field light generating region calculating unit 4104, an excitation signal output unit 4105, and a piezo driver control unit 4106. Here, the components designated with the same numbers as the numbers in the third embodiment in FIG. 14A have the same functions described in the third embodiment.

In the configuration described above, the signal switching circuit unit 4101 switches the destination of the signal outputted from the feedback controller 113 based on positional information about the X stage 106 and the Y stage 105 outputted from the inspection stage 101. Namely, when the probe 120 is scanning the region including the magnetic field generating region 3 of the thermal assist type magnetic head device unit 4, the signal outputted from the feedback controller 113 is outputted to the MFM image generating unit 4102 side together with positional information about the X stage 106 and the Y stage 105 outputted from the inspection stage 101.

On the other hand, when an AFM image of the region including the near-field light generating region 2 is acquired, the probe 1120 scans the region including the near-field light generating region 2 of the thermal assist type magnetic head device unit 4 in the state in which the oscillations of the cantilever 100 are stopped and the constant gap d′ is maintained between the probe 1120 and the surface of the thermal assist type magnetic head device unit 4. In this case, the signal outputted from the feedback controller 113 is outputted to the binarization circuit unit 4301 side together with positional information about the X stage 106 and the Y stage 105 outputted from the inspection stage 101. Since signal processing from the binarization circuit unit 4301 to the quality determining unit 4304 is the same as processing in the control unit PC 30 described in the third embodiment, the description is omitted.

The MFM image generating unit 4102 receives the signal outputted from the DC converter 112 through the feedback controller 113, and forms an MFM image using the signal outputted from the feedback controller 113 and positional information about the X stage 106 and the Y stage 105 outputted from the inspection stage 101.

The formed MFM image is sent to the magnetic field generating position detecting unit 4103 for image processing, and the position of the magnetic field generating region 3 is identified on the MFM image. Subsequently, positional information about the identified magnetic field generating region 3 is sent to the near-field light generating region calculating unit 4104, and positional information about the near-field light generating region 2 is obtained from positional information about the magnetic field generating region 3 based on design information about the thermal assist type magnetic head device unit 4. The positional information about the near-field light generating region 2 is sent to the piezo driver control unit 4106. The piezo driver control unit 4106 controls the piezo driver 107 to drive the X stage 106 and the Y stage 105 based on the positional information about the near-field light generating region 2, and positions the near-field light generating region 2 in the range of the scan region of the probe 120 formed with the magnetic film 1121 on the surface.

Since the procedures of scanning the region including the near-field light generating region 2 with the probe 1120 to acquire an AFM image and evaluating the physical shape of the near-field light generating region 2 are the same as the procedures described in the third embodiment, the description is omitted.

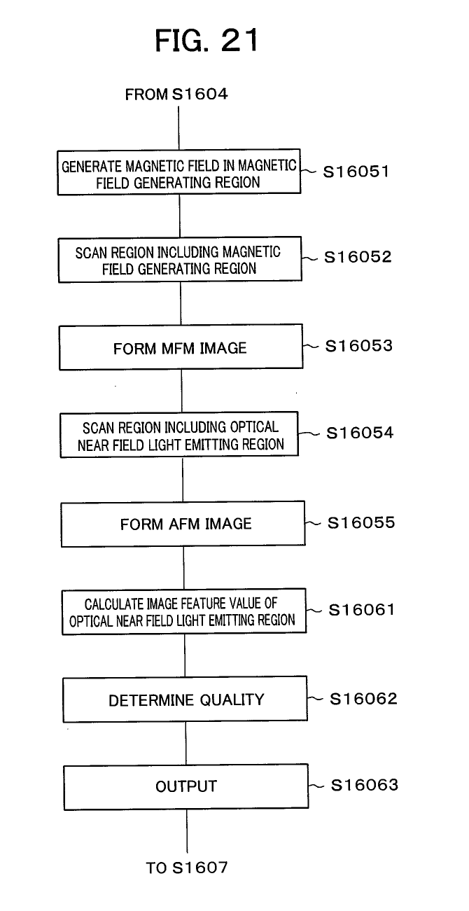

The operation procedures of the thermal assist type magnetic head inspection apparatus 8000 according to the embodiment are the same as the operation procedures described in the third embodiment with reference to FIG. 16, except S1605 and S1606. The portions different from the flowchart of the third embodiment in FIG. 16 will be described with reference to FIG. 21.

After completion in S1604, the excitation signal output unit 4105 receives positional information about the X stage 106 and the Y stage 105 outputted from the inspection stage 101, outputs a signal to generate a magnetic field on the magnetic field generating region 3 of the thermal assist type magnetic head device unit 4 formed in the row bar 1 through the signal line 301, and generates a magnetic field on the magnetic field generating region 3 (S16051). Subsequently, the oscillating unit 122 drives the cantilever 100 formed with the magnetic film 121 on the surface to oscillate the cantilever 100 at a constant amplitude. In the oscillation, the position of the cantilever 100 in the Z-direction is adjusted by the Z stage 104. Thus, the probe 1120 fixed near the tip end portion of the cantilever 100 scans the region including the magnetic field generating region 3 on which a magnetic field is generated in the state in which the constant gap d′ is maintained at the lowest point for oscillations with respect to the thermal assist type magnetic head device unit 4 (S16052), and an MFM image of the magnetic field generating region 3 is created at the MFM image forming unit 4102 (S16053).

Subsequently, the position of the magnetic field generating region 3 is identified on the created MFM image, and the position of the near-field light generating region 2 (the amount of movement to the near-field light generating region 2) on the X stage 106 and the Y stage 105 is calculated from the position relationship between the identified positional information and the positions of the magnetic field generating region 3 and the near-field light generating region 2 on design data stored in advance. The X stage 106 and the Y stage 105 are then driven by the piezo driver 107 based on the calculated amount of movement, and the near-field light generating region 2 is moved into the scan range of the probe 1120. Subsequently, the signal to generate a magnetic field on the magnetic field generating region 3 of the thermal assist type magnetic head device unit 4 formed in the row bar 1 from the signal line 301 is interrupted, and the output of the oscillating unit 122 is stopped to halt the oscillations of the cantilever 100. Subsequently, as similar to the case of the first embodiment, the probe 1120 scans the region including the near-field light generating region 2 in the state in which the constant gap d′ is maintained between the cantilever 100 and the thermal assist type magnetic head device unit 4 (S16054), and an AFM image of the region including the near-field light generating region 2 is formed at the AFM image forming unit 4302 (S16055).

Moreover, the AFM image is processed to calculate image feature values D1 and D2 of the near-field light generating region 2 (S6061), and the feature values D1 and D2 are compared with preset reference values to evaluate the physical shape of the near-field light generating region 2 for determining the quality (S6062). Lastly, the found results are outputted to an input/output unit 31 together with the MFM image and the phase difference image (S6063).

It is noted that in the embodiment described above, it is described in which inspection is performed in the state of the row bar 1. However, the embodiment is not limited thereto. Such a configuration may be possible in which a single slider (the thermal assist type magnetic head device 4) cut out from the row bar 1 is placed on a mounting unit 114 for similar inspection as described above.

According to the embodiment, the near-field light generating region of the thermal assist type magnetic head device can be inspected without emitting a near-field light in a relatively early stage of the manufacturing process steps of the thermal assist type magnetic head device, in a row bar state, for example. Moreover, it is unnecessary to equip a mechanism to emit a near-field light on the inspection apparatus, so that the configuration of the inspection apparatus can be relatively simplified.

Also in the embodiment, as similar to the description in the third embodiment with reference to FIG. 17, such a configuration may be possible in which the tip end portion of the probe 1120 includes a small-gage wire formed of a relatively hard material (corresponding to the small-gage wire 1201 in FIG. 17), a magnetic film is formed on the surface of the small-gage wire, and the surface of the row bar 1 is scanned using the small-gage wire formed with the magnetic film on the surface. For a material of forming the small-gage wire, any one of carbon nanofiber (CNF), a carbon nanotube (CNT), a high density carbon (HDC:DLC), and tungsten (W) may be used. With this configuration, the small-gage wire 1201 of a relatively hard material contacts the thermal assist type magnetic head device 4 formed in the row bar 1, and the lifetime of the cantilever 100 can be prolonged more than in the case where the probe 1120 is directly contacted.

As described above, the invention made by the present inventor is described specifically based on the embodiments. However, it is without saying that the present invention is not limited to the embodiments, and can be modified and altered variously within the scope not deviating from the teachings.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. An inspection apparatus for a thermal assist type magnetic head device, the apparatus comprising:
a table unit on which a thermal assist type magnetic head device formed with a near-field light emitting portion is placed, the table unit being movable in a plane, the thermal assist type magnetic head device being a sample;
a cantilever including a probe to scan a surface of the sample placed on the table unit;
an oscillation drive unit configured to vertically oscillate the cantilever with respect to the surface of the sample;
a displacement detection unit configured to detect oscillations of the cantilever by applying light to a face opposite to a face on which the probe of the cantilever is formed and detecting reflected light from the cantilever, the cantilever being oscillated by the oscillation drive unit;
a phase difference detection unit configured to detect a phase difference between a drive signal to vertically oscillate the cantilever by the oscillation drive unit and a detection signal obtained by detecting oscillations of the cantilever at the displacement detection unit;
a phase difference image forming unit configured to form a phase difference image of the thermal assist type magnetic head device using information about the phase difference detected at the phase difference detection unit and positional information about the table unit, and
a determining unit configured to determine quality of the near-field light emitting portion formed on the thermal assist type magnetic head device by processing the phase difference image formed at the phase difference image forming unit.

2. The inspection apparatus for a thermal assist type magnetic head device according to claim 1, wherein a plurality of the thermal assist type magnetic head devices is formed on a row bar, and the plurality of the thermal assist type magnetic head devices formed on the row bar is inspected.

3. The inspection apparatus for a thermal assist type magnetic head device according to claim 1,
wherein the displacement detection unit detects a change in a phase of oscillations between when the cantilever scans a place where the near-field light emitting portion of the thermal assist type magnetic head device is formed and when the cantilever scans a place other than the place where the near-field light emitting portion is formed, and
the phase difference detection unit detects the change in the phase of oscillations detected at the displacement detection unit as a phase difference from the drive signal to vertically oscillate the cantilever by the oscillation drive unit.

4. The inspection apparatus for a thermal assist type magnetic head device according to claim 1, wherein a magnetic film is formed on a surface of the probe.

5. The inspection apparatus for a thermal assist type magnetic head device according to claim 1, wherein the probe of the cantilever is mounted with a small-gage wire formed of any one of carbon nanofiber (CNF), a carbon nanotube (CNT), high density carbon (HDC:DLC), and tungsten (W).

6. An inspection apparatus for inspecting a thermal assist type magnetic head device, the apparatus comprising:
a table unit on which a thermal assist type magnetic head device formed with a near-field light emitting portion is placed, the table unit being movable in a plane, the thermal assist type magnetic head device being a sample;
a cantilever including a probe to scan a plane apart at a constant distance from a surface of the sample placed on the table unit;
a displacement detection unit configured to detect a displacement of the cantilever scanning the plane apart at a constant distance from the surface of the sample by applying light from a light projecting device to a face opposite to a face on which the probe of the cantilever is formed and detecting reflected light from the cantilever using a photodetector;
an atomic force microscope (AFM) image forming unit configured to form an AFM image of the thermal assist type magnetic head device using a detection signal obtained by detecting the displacement of the cantilever at the displacement detection unit and positional information about the table unit, and
a determining unit configured to determine quality of a physical shape including a size or typical dimensions of the near-field light emitting portion formed on the thermal assist type magnetic head device by processing the AFM image formed at the AFM image forming unit.

7. The inspection apparatus for a thermal assist type magnetic head device according to claim 6, wherein a plurality of the thermal assist type magnetic head devices is formed on a row bar, and the plurality of the thermal assist type magnetic head devices formed on the row bar is inspected.

8. The inspection apparatus for a thermal assist type magnetic head device according to claim 6, wherein the displacement detection unit detects the displacement of the cantilever using a signal obtained by detecting the reflected light from the cantilever using the photodetector when the probe is scanning a place where the near-field light emitting portion of the thermal assist type magnetic head device is formed and a signal obtained by detecting the reflected light from the cantilever using the photodetector when the probe is scanning a place other than the place where the near-field light emitting portion of the thermal assist type magnetic head device is formed.

9. The inspection apparatus for a thermal assist type magnetic head device according to claim 6,
wherein a magnetic field generating region is formed on the thermal assist type magnetic head device;
the inspection apparatus for a thermal assist type magnetic head device further comprising:
a magnetic field generating unit configured to generate a magnetic field on the magnetic field generating region of the thermal assist type magnetic head device; and
an oscillating unit configured to oscillate the cantilever, a magnetic film being formed on a surface of the probe, and
a magnetic force microscope (MFM) image is acquired by driving the table unit while oscillating the cantilever with the oscillating unit in a state in which a magnetic field is generated on the magnetic field generating region of the thermal assist type magnetic head device using the magnetic field generating unit and scanning a region including the magnetic field generating region of the thermal assist type magnetic head device with the probe formed with the magnetic film on the surface of the probe.

10. The inspection apparatus for a thermal assist type magnetic head device according to claim 6, wherein the probe of the cantilever is mounted with a small-gage wire formed of any one of carbon nanofiber (CNF), a carbon nanotube (CNT), high density carbon (HDC:DLC), and tungsten (W).

11. A method for inspecting a thermal assist type magnetic head device comprising the steps of:
placing a thermal assist type magnetic head device formed with a near-field light emitting portion on a table movable in a plane, the thermal assist type magnetic head device being a sample;
scanning a surface of the sample placed on the table with a probe by vertically oscillating a cantilever including the probe over the surface of the sample while moving the table in a plane;
detecting oscillations of the cantilever by applying light to a face opposite to a face on which the probe of the cantilever scanning the surface of the sample is formed and detecting reflected light from the cantilever;
detecting a phase difference between a drive signal to vertically oscillate the cantilever and a detection signal obtained by detecting oscillations of the cantilever, and
determining quality of the near-field light emitting portion formed on the thermal assist type magnetic head device using information about the detected phase difference.

12. The method for inspecting a thermal assist type magnetic head device according to claim 11,
wherein the determining quality of the near-field light emitting portion formed on the thermal assist type magnetic head device using information about the detected phase difference includes:
forming a phase difference image of the thermal assist type magnetic head device using information about the detected phase difference and positional information about the moving table, and
determining quality of the near-field light emitting portion formed on the thermal assist type magnetic head device by processing the formed phase difference image.

13. The method for inspecting a thermal assist type magnetic head device according to claim 11, wherein a plurality of the thermal assist type magnetic head devices is formed on a row bar, and the plurality of the thermal assist type magnetic head devices formed on the row bar is inspected.

14. The method for inspecting a thermal assist type magnetic head device according to claim 11,
wherein oscillations of the cantilever are detected to detect a change in a phase of oscillations between when the cantilever scans a place where the near-field light emitting portion of the thermal assist type magnetic head device is formed and when the cantilever scans a place other than the place where the near-field light emitting portion is formed, and
the detecting the phase difference is to detect the detected change in the phase of oscillations as a change in a phase difference from the drive signal to vertically oscillate the cantilever.

15. The method for inspecting a thermal assist type magnetic head device according to claim 11,
wherein a magnetic film is formed on a surface of the probe;
the probe scans a region where the magnetic film is formed while vertically oscillating the cantilever;
a magnetic force microscope image in the region where the magnetic film is formed is formed using a signal detecting oscillations of the cantilever the scanning; and
quality of the near-field light emitting portion formed on the thermal assist type magnetic head device is determined by processing the formed magnetic force microscope image and the formed phase difference image.

16. A method for inspecting a thermal assist type magnetic head device comprising the steps of:
placing a thermal assist type magnetic head device formed with a near-field light emitting portion on a table movable in a plane, the thermal assist type magnetic head device being a sample;
scanning a plane apart at a constant distance from a surface of the sample placed on the table with a probe fixed to a cantilever while moving the table in a plane;
detecting a displacement of the cantilever by applying light to a face opposite to a face on which the probe of the cantilever scanning the surface of the sample is formed and detecting reflected light from the cantilever;
forming an atomic force microscope (AFM) image of the thermal assist type magnetic head device using information about the detected displacement of the cantilever and positional information about the table on which the thermal assist type magnetic head device being the sample is placed, and
determining quality of a physical shape including a size or typical dimensions of the near-field light emitting portion formed on the thermal assist type magnetic head device by processing the formed AFM image of the thermal assist type magnetic head device.

17. The method for inspecting a thermal assist type magnetic head device according to claim 16,
wherein the determining quality of a physical shape including a size or typical dimensions of the near-field light emitting portion formed on the thermal assist type magnetic head device using information about the formed AFM image includes:
forming an AFM image of the thermal assist type magnetic head device using information about the detected displacement of the cantilever and positional information about the moving table, and
determining quality of a physical shape of the near-field light emitting portion formed on the thermal assist type magnetic head device by processing the formed AFM image.

18. The method for inspecting a thermal assist type magnetic head device according to claim 16, wherein a plurality of the thermal assist type magnetic head devices is formed on a row bar, and the plurality of the thermal assist type magnetic head devices formed on the row bar is inspected.

19. The method for inspecting a thermal assist type magnetic head device according to claim 16, wherein the displacement of the cantilever between when the probe scans a place where the near-field light emitting portion of the thermal assist type magnetic head device is formed and when the cantilever scans a place other than the place where the near-field light emitting portion is formed is detected from a change in a position of the reflected light from the cantilever.

20. The method for inspecting a thermal assist type magnetic head device according to claim 16,
wherein a magnetic film is formed on a surface of the probe;
the probe of the cantilever scans a plane apart at a constant distance from a region in which the magnetic film is formed on the surface of the sample placed on the table while moving the table in a plane, the probe being formed with the magnetic film on the surface of the probe, and
forming a magnetic force microscope (MFM) image of the region in which the magnetic film is formed using a signal detecting the displacement of the cantilever in the scanning.
